(19) United States
(12) Patent Application Publication
(10) Pub. No.: US 2026/0312879 A1
(43) Pub. Date: Oct. 8, 2026

(54) SYSTEMS AND METHODS FOR FEDERATED LEARNING ENABLED 5G/6G MULTI-TASK SEMANTIC COMMUNICATIONS FRAMEWORK

(71) Applicant: ODINELABS INC, Marietta, GA (US)

(72) Inventors: Umuralp KAYTAZ, Istanbul (TR); Ian Fuat Akyildiz, Alpharetta, GA (US); Bulent Kaytaz, Istanbul (TR)

(21) Appl. No.: 19/172,035

(22) Filed: Apr. 7, 2025

(51) Int. Cl. H04L 41/16; G06N 3/098; H04L 41/14

(52) U.S. Cl. CPC H04L 41/16; G06N 3/098; H04L 41/145

(57) ABSTRACT

Example implementations encompass systems and methods for federated learning-assisted multi-task semantic communications tailored for 5G/6G wireless systems. A Centralized Server (CS) hosts a knowledge base with interconnected Machine Learning (ML)-based semantic codec models, extracting and synthesizing semantic information across various tasks using single or multi-modal observations. The CS connects with Decentralized Servers (DSs) and Edge Servers (ESs), which handle task-related data transmission and reception. This setup enables training of global models for semantic communications through federated learning. ML models in DS knowledge bases allow local model updates, leveraging ES-assisted transmissions via a Local Model Aggregator (LMA). The CS aggregates model weights from the DSs using a Global Model Aggregator (GMA). Semantic transmission requests can be initiated from ESs and forwarded to the CS, which responds by providing semantic encoding and decoding models to ensure efficient communication of semantic information between involved parties.

### FIELD

The present disclosure pertains to the fields of 5G/6G wireless communications and artificial intelligence, with a focus on systems and methods that leverage federated learning to enhance multi-task semantic communications.

### BACKGROUND

In recent years, wireless networks have increasingly prioritized intent (i.e., semantics) and performance over the mere completeness of transmitted information. In other words, wireless networks have evolved from a networking paradigm focused on digitization of connected devices to intellectualization employing connected intelligence. Traditional content-centric, data-driven communication architectures are frequently unable to satisfy high Quality-of-Experience (QoE) demands by users in resource-intensive human-centric and agent-centric 6G networks. One of the key motivations behind the surge in semantic communications is emerging services in 6G networks. For example, virtual universes such as the “Metaverse” are expected to require low-latency and high volume data transmissions in order to synchronize physical and virtual domains and thereby host a massive quantity of connected objects such as robots and transportation vehicles that require multi-modal, low-latency, and reliable transmissions. These requirements are further expected to cause a massive increase in network resource overhead in order to satisfy diverse Quality-of-Service (QoS) and/or Quality-of-Experience (QoE) requirements. Semantic communications can address these 6G networking issues by providing ultra-high transmission efficiency using extracted Semantic Information (SI), improving transmission effectiveness with semantic reasoning in the presence of environmental noise, and improving ease-of-deployment over existing communication infrastructure.

Neural Networks (NNs) are powerful Machine Learning (ML) models that are adept at processing complex data (e.g., one or more data sets, streams, or other data structures) and capturing intricate patterns with non-linear relationships. Furthermore, NNs can learn implicitly and store semantically overlapping task features while containing similar layer-wise structures for semantically related computational tasks. For example, for a given data set, multiple image related SI extraction tasks can be performed with minor modifications (i.e., architectural NN modifications) such as layer addition to the NN, masking of a NN layer, drop-out and/or pooling to a shared NN architecture in order to obtain a high-level SI containing an image summary and then extracting low-level SI for object recognition using the shared NN model. For example, a NN model can be shared by an FL coordinator with one or more network nodes involved in semantic communications for task specific usage or weight update (e.g., during training) and stored in one or more KB of node(s) involved in semantic communications. This can be performed periodically or aperiodically based on a request before training or before transmission. Similarly, multiple tasks that require multi-modal SI extraction can be realized using multi-modal NN architectures and layer-wise NN modifications.

Turning to a related topic, Federated Learning (FL) is a subfield of ML that is focused on training models over a plurality of decentralized devices or nodes without the use of a central server. FL can be an effective privacy-preserving approach for collaborative training of models in data-driven applications. Traditionally, FL frameworks have adopted a distributed approach to train a specific NN-based model, typically during the performance of a single, overarching, static task.

In yet another related topic, Multi-Task Semantic Communications (MTSC) can be NN-based, and each of the multiple tasks can be processed sequentially or simultaneously. In various instances, this sequential or simultaneous task processing may require specific computational requirements, ML configurations and hyperparameters. For example, while a summarization of frame information task can focus on global context within a frame, an object detection task can emphasize localized features and attention mechanisms.

Semantic communications are a field of technology that is poised to greatly enhance 6G communication capabilities within existing legacy networking infrastructures. As interest in leveraging artificial intelligence (AI) for optimizing telecommunications networks grows, several schemes have been proposed for machine learning (ML) and neural network (NN)-based semantic information (SI) extraction in these networks. Most of these proposed schemes focus on using task-specific ML models or data modalities and primarily rely on a single knowledge base (KB) within a network topology.

Deep learning-based methods have been proposed for single-task, single-modality SI extraction across various forms of data, including text, images, videos, speech, and task execution-related information. Similarly, multi-task, single-modal SI extraction has been explored in the context of visual information transmission, particularly for image detection, classification, or segmentation tasks. In some instances, a multi-task framework that can utilize a shared semantic transmitter architecture in network nodes for a predetermined set of tasks. However, these approaches require task-specific training and transceiver utilization, thereby limiting their ability to be generalized across different semantic source and destination pairs.

In some instances, a semantic communication-assisted bidirectional caching mechanism has been used for interactive AR/VR (Augmented/Virtual Reality) games, which employs modality-specific channel and semantic encoder/decoder blocks. In some instances, a unified deep learning-based semantic communication system (U-DeepSC) has been used, which emphasizes task-specific feature pruning and codebook utilization during semantic communications. This can reduce ML training and transmission overhead. However, this method requires separate ML models for each modality during a semantic encoding process, along with distinct semantic and channel encoding and decoding blocks for respective source and destination pairs.

Federated Learning (FL) for multi-task learning has been used for distributed training-based beamforming optimization in Integrated Sensing and Communication (ISAC) networks and computational offloading in Mobile Edge Computing (MEC) units. However, this approach focuses on raw data transmissions without SI extraction. In some instances, resource-restricted semantic communications with relay-assisted transmissions concentrate solely on textual information, utilizing dedicated task-specific semantic encoding/decoding blocks. In some instances, federated learning-based training optimization in semantic communication networks has been used. However, this approach focuses exclusively on image transmission tasks using task-specific shifted-window (swin) transformer blocks for single-modal SI extraction.

In some instances, a distributed system with cross-modal SI extraction for Audio-Visual Parsing (AVP) tasks has been used. While this method encompasses AVP-related multi-task procedures with transformer blocks, it fails to address the ability to generalize an ML model for dynamic task allocation or textual information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The disclosure herein includes implementation of distributed learning, privacy preservation, and utilization of up-to-date data through FL with unified NN-based architectures in SeCo encoder and/or decoder components of semantic-oriented communications.

The principles underlying the systems, methods, and apparatuses described herein allow for their application across diverse architectures, including Mobile Network Operator (MNO) subnetworks, Industrial IoT (IIoT) networks, private networks, Intelligent Transportation Systems (ITS), and other architectures and it should be understood that the various aspects described herein are for illustrative purposes and not exhaustive. In some aspects, the application of these principles can be used to facilitate cooperative and distributed learning for multi-task semantic transmissions. The various aspects described herein operate to effectively integrate concepts from the fields of artificial intelligence and wireless communications, providing innovative solutions in the realm of semantic communications. The various aspects described herein address evolving and emerging needs in 5G and/or 6G wireless systems.

One key enabler of semantic communication technologies is the use of one or more processes of SI extraction by paired Semantic Codecs (SeCos) in the network source-destination nodes. By employing ML techniques, particularly Neural Network (NN)-based models (e.g. transformers, autoencoders, Structured State Space Sequence (S4), and other ML/NN-based models) for semantic encoding and decoding procedures, meaningful semantic features can be extracted from single-modal or multi-modal input observations. These features, which may include embeddings, scores, and tags, can significantly enhance various aspects of wireless communication systems, including bandwidth utilization, energy efficiency, adaptability to error tolerance, latency management, and contextual understanding.

With the advent of 6G applications, multiple tasks and agent environments with their unique application domains are expected to coexist within the wireless communication environment. 6G agents with cognitive sensing abilities, understanding, and reasoning, can use sensory measurements to process shared or separate surrounding Semantic Sources (SS). Transmitted data can exhibit multi-modality, with each modal representation containing diverse semantic content. For example, a video stream can be semantically encoded to identify a quantity of individuals present and/or to detect specific facial expressions and gestures (such as facial orientation, emotional state, or other facial semantic information) of one or more persons in the video stream, derived from frame information. In some examples, an audio component of the video stream can be semantically encoded for speech recognition tasks concurrent with the semantic encoding. Moreover, a subset of correlated or uncorrelated tasks related to the communication system can be dynamically redefined based on evolving requirements of the system or QoS/QoE, allowing for simultaneous semantic processing of multiple tasks.

FL can be effectively utilized to develop dynamic SeCo models for SI encoding and decoding procedures that cater to a multitude of tasks existing simultaneously across different segments of a communication network. Using the distributed model training abilities of FL can improve the robustness of global SeCo models against diverse semantic noise and semantic ambiguity levels. This can be a result of weight aggregation procedure(s) of the FL environment that are operable to utilize multiple localized training instances with diverse physical and semantic channel conditions.

Maintaining a unified and flexible SeCo architecture for multiple tasks based on a shared NN model can reduce resource overhead significantly in learning procedures requiring the performance of multiple tasks. Furthermore, a unified NN-based SeCo architecture is operable to enable shared learning of common features and improve a generalization of trained NN architectures in both single and multi-modal SI transmissions. For scenarios where one or more inputs span multiple modalities (e.g., where inputs may include text, video, and/or audio), a task agnostic architecture with input and/or output processing and model configuration options can serve diverse goals and task-specific adaptations. This can help bridge semantic gaps and enhance task interoperability, while also reducing computational overhead.

MTSC may necessitate training of one or more coupled semantic encoder and/or decoder units following any task updates or channel condition changes using a shared Knowledge Base (KB). For a FL-enabled MTSC, multi-task trained global NN weights and task-specific NN-based ML model configurations of coupled semantic encoder and decoder SeCo units can be maintained as global KB models and configurations, which can then be shared among distributed transmitter, receiver, and/or hybrid transmitter/receiver nodes. By leveraging these shared models, multiple FL training iterations can be conducted that align with diverse semantic and channel noise effects. For example, aligning can include adaptation(s) to channel noise and/or semantic noise dynamics and/or characteristics. Accordingly, adaptation can include performance enhancement in the presence of noise in the channel.

Attempting to conduct semantic communication training procedures without FL—namely by attempting to perform training procedures in a centralized manner at a single network node (e.g., at a single central server)—may have several drawbacks. First, single network node training procedures can impose a significant computational burden on the single central server tasked with learning the encoder and decoder models for various task-specific semantic communications. Second, the single central server may require access to global model data during training, which can pose privacy risks to network data and potentially create traffic bottlenecks for the single central server. Lastly, if the global model data is not continuously updated to reflect application-specific dynamic network traffic, any employed models may overfit to the respective model(s) to the training data, leading to poor generalization of ongoing, evolving traffic conditions.

In order to improve upon proposed schemes regarding Semantic Communications, privacy-preserving collaborative training of ML models can enable their use for large-scale systems.

A unified and configurable Semantic Codec (SeCo) architecture is disclosed herein that is designed to extract SI that is related to multiple tasks and modalities. Further, employment of federated learning with Task-Specific ML Configurations (TSMLCs) facilitates the efficient collaborative training of encoding and decoding NN models. This approach enables iterative updates of both global KBs and local KBs during a federated learning process, rather than relying on a single, static KB for task-specific and modality-specific SI extraction.

In some aspects, an innovative system for FL-Assisted MTSC is described. An architecture is described comprising a Central Server (CS) that operates in conjunction with multiple Decentralized Server (DS) nodes. These DS nodes are responsible for coordinating localized training and transmission procedures of task-adaptive NN-based SeCo architectures, namely Semantic Data Transformation Modules (SDTMs), for SI related encoding/decoding procedures. One or more DS can manage local and area-specific semantic transmissions in diverse agent environments and application domains, enhancing the overall efficiency and effectiveness of the communication network. Each DS can connect to one or more Edge Server (ES) units, which execute local computations for Radio Access Networks (RANs) that contain various Wi-Fi and/or IoT Access Points (APs) or employ 5G/6G Base Stations (BSs) for wireless communications. Each ES can be equipped with cognitive sensing and communication modules capable of capturing and processing SI. Additionally, the servers (e.g., one or more CS, DS and/or ES) maintain a KB that acts as repository of versioned NN model weights and task-specific configuration files, which are either received or updated during FL training iterations, enabling utilization of previously trained peak-performing ML models in case most recent FL training does not meet MTSC QoS/QoE standards.

Each node capable of participating in semantic communication can include one or more SDTMs, which acts as SeCos and can perform Task Specific Input Modifications (TSIMs), Task Specific Layer Modifications (TSLMs) and necessary SI-related post-processing functions. TSIMs aim to modify provided input data by applying a subset of possible techniques such as task specific token insertion, task specific embedding, task specific positional encoding or task specific byte patch insertion. TSLMs can focus on modification of a NN for task-adaptive computations applying a subset of procedures such as task specific attention head selection, task specific layer augmentation, task specific layer routing, task specific attention masking, task specific layer normalization, and/or task specific layer masking. Configurations and computational details of each task-specific TSIM and TSLM steps can be shared within the network before or during MTSC in terms of Task-Specific ML Configurations (TSMLCs) which are synchronized among DSs and shared with associated ESs preventing resource overhead with the utilization of a unified and flexible SeCo architecture during semantic encoding and decoding iterations.

A Central Server (CS) (also referred to herein as a Centralized Server) functions as a global FL coordinator, overseeing the network-wide coordination of KB and global ML models. The CS distributes model weights and TSMLCs of semantic encoder and decoder SeCo couples to the DS nodes, which serve as local FL coordinators. Transmitter and receiver ESs, located throughout the subnetworks of DSs, receive these global models from their corresponding DS. In certain configurations, transmitter and receiver ESs may be managed by different DSs, allowing for the separation of encoder and decoder models for specific tasks while facilitating cooperative training. These separate DSs can share model weights during a training process through message-based learning updates for the connected ESs. During local FL training rounds, DSs are configured to update their stored KB models after the execution of performance convergence tests using task-specific accuracy and/or loss performance information of ESs. Following training rounds, the CS statistically aggregates local ML model weights from each DS, which have been trained using communication data from the ESs. Local updates can occur over a predetermined number of training iterations before the global models are updated in the CS and redistributed to the DSs. FL can support and promote privacy by keeping data localized, which is crucial and beneficial in modern data-sensitive communication environments. Also, by distributing the learning process and coordination of models and configurations, the systems and method disclosed herein can reduce computational loads on central servers, thereby preserving precious scarce resources and improving overall system efficiency for MTSC.

Each server (e.g., one or more CS, DS, and/or ES) also features forwarding modules that relay SDTM model weights and TSMLCs to other DSs and individual ES units involved in the semantic communication process. Data-driven ML model updates can be performed sequentially or simultaneously for each task, coordinated by both the global and local FL coordinators. NN models received from transmitter and receiver nodes contribute to updating global models stored in both the CS and the DSs. Unlike traditional task-specific ML model training in semantic communication systems, the ability to handle multiple tasks simultaneously as well as sequentially and adapt to changing network conditions with a unified computational framework is a significant advantage, enhancing efficiency and performance and preserving resources in semantic communications.

Semantic transmission tasks can be assigned based on a task list maintained by the CS. This task list can be periodically updated through external access or internal network requests with the respective TSMLCs. Externally, updates may occur via third-party access or services provided by communication or AI service providers. Internally, AI procedures in the ESs can send requests to the CS, relayed through the DS, to transmit or receive task-specific semantic information. Pairs or groups of nodes can be identified within the network for task-specific transmission or training, in some instances when they are in an idle state. Local ML model training updates can be coordinated by DSs using the global KB distributed by the CS or previously stored knowledge (e.g., local KBs) in the DS. Both transmitter and receiver ESs can have direct or relayed access to their local FL coordinator (i.e., DS). ML models can be updated based on the performance of ongoing semantic transmissions using various optimization techniques, such as back propagation, reinforcement learning, heuristic strategies, and evolutionary learning, during the FL-based ML training process. Subsequently, these locally updated models can be sent to the CS or other DSs for global or local model updates. Ultimately, finalized model weights are forwarded to the CS to update the global model repository within the global FL coordinator KB. Updated global model is shared by the CS during or before transmissions with the DSs for updating their locally stored KB models. Therefore, the proposed systems and methods can minimize or eliminate network bottlenecks that can occur for model access to a CS by maintaining up-to-date models in DS KB repositories.

Each ES can comprise one or more SeCo SDTMs and channel encoders for semantic and physical channel transmissions, respectively. Each SDTM can employ one or more TSMLCs for performing input modifications via TSIM blocks and NN model modifications via TSLM functions. In the unified architecture of SDTM, one or more NN-based learning models are used for SI-related non-linear function approximation or desired input-to-output mapping. Post-processing can be applied to the output of the NN-based learning model if necessary. Using a pre-determined combination of TSMLCs and ML models, SDTMs are used as semantic encoder/decoder units during training or semantic transmissions. Semantic compression on the received input data or other observations, which can be single-modal or multi-modal, can be applied for extracting the correlated SI. During transmission on the physical channel, semantically compressed SDTM output can be forwarded to the channel encoder block. One or more SDTMs can operate simultaneously or be isolated from each other for distinct modalities or task settings. Similarly, on the receiver side, received signals and SI can be processed simultaneously or separately for separate task-specific semantic transmissions. Received input(s) (e.g., data) can be processed by the channel decoder and forwarded to the SDTM in the receiver that is coupled with the semantically encoding SeCo SDTM of the transmitter. Receiver SeCo SDTM semantically decompresses the received and channel decoded transmissions. Output of the receiver SeCo SDTM can be directly used by other applications or forwarded to another network node. Employment of the SDTM architecture with shared model weights and TSMLCs prevents resource overhead of separated task-dependent training and storage processes for semantic encoders and decoders. This can improve efficiency and resource utilization during semantic communications.

A CS that is equipped for FL coordination can include a Global Model Aggregator (GMA) that utilizes the global weights of locally trained task-specific SDTM encoder and/or decoder models. The GMA can calculate global ML model weights through statistical aggregation of locally trained ML model weights. In the global KB, the ML models can be systematically updated for distribution to the FL client nodes in subsequent stages. Each DS can be equipped with a Local Model Aggregator (LMA), which is responsible for training one or both of encoder and decoder SeCO SDTM blocks. This training can occur after establishing connections with both ends of a communication (i.e., transmitter and receiver nodes) using a shared loss function. Alternatively or additionally, the LMA can receive the weights of the SDTM ML/NN models that are forwarded by other DSs.

In certain aspects, multiple DSs can coexist within a subnetwork, functioning as local FL coordinators. These DSs functioning as local FL coordinators can perform weight aggregation for the encoder or decoder SDTM NNs on behalf of the same transmission parties. In scenarios where different model outcomes arise after executing multiple training rounds, overlapping local FL coordinators have mechanisms to synchronize their models. They can employ majority voting to determine the most accurate model outcome or update their model states based on the insights from the highest performing based SI performance metrics or most experienced FL coordinator, specifically the FL coordinator with the longest service duration. This collaborative approach not only enhances the robustness of the model training process but also ensures that the aggregated models reflect a consensus that is representative of the collective learning experiences across the network. By leveraging the strengths of multiple coordinators, the overall efficiency and accuracy of the model can be significantly improved, leading to better performance in real-world semantic communication applications.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

In some aspects, the techniques described herein relate to a system of Multi-Task Semantic Communications (MTSC) via Federated Learning (FL), including: a central server (CS) configured to coordinate the federated learning (FL); one or more decentralized server (DS) nodes communicatively coupled to the CS and configured to coordinate localized training and transmission procedures of task adaptive neural network (NN) based Semantic Codec (SeCo) architectures; one or more edge server (ES) units coupled to the one or more DS nodes and configured to execute local computations for radio access networks (RANs); and one or more knowledge base (KB) database configured to store one or more of versioned NN model weights and task-specific SeCo configuration files.

In some aspects, the techniques described herein relate to a method of federated learning (FL) for Multi-Task Semantic Communication (MTSC), including: transmitting, from a centralized server (CS), a global knowledge base (KB) including Semantic Data Transformation Models (SDTM) models and configurations with one or more communicatively coupled local FL distributed servers (DSs); updating, at the one or more DSs, the SDTM models and the configurations; transmitting, from the one or more DSs, an updated SDTM model and the configurations to one or more communicatively coupled edge servers (ESs); extracting, at the one or more ESs, semantic information (SI); and checking, at the one or more DSs, a convergence using information from selected trained ESs.

In some aspects, the techniques described herein relate to a method of multi-task semantic communication using a single Semantic Information Source (SIS), including: receiving, at a source edge server (ES), SIS information; performing cognitive sensing on the SIS information; performing semantic encoding of a Semantic Data Transformation Model (SDTM); performing channel encoding of semantically encoded information; transmitting the encoded channel to a destination ES; performing channel decoding of the semantically encoded information; and performing semantic decoding of the channel decoded information.

In some aspects, the techniques described herein relate to a method of locally coordinated federated learning (FL) using multiple distributed servers (DSs), including: transmitting, from a source edge server (ES) to a destination edge server ES), a request for a task set; synchronizing, for the source ES and destination ES, a local knowledge base (KB); transmitting, from the source ES, a request for the task set to a first DS associated with the source ES; forwarding, from the first DS to a second DS associated with the destination ES, the request for the task set; transmitting, from the second DS to the destination ES, a Semantic Data Transformation Models (SDTM) version and a Task-Specific Machine Learning Configuration (TSMLC) for the task set; transmitting, from the destination ES to the second DS, a SDTM status for the task set; synchronizing, for the first DS and second DS, KB for a transmission of the task set; and transmitting a SDTM update from the first DS to the source ES and from the second DS to the destination ES.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram showing semantic wireless communication-enabled network, in accordance with aspects of the disclosure;

FIG. 2 is a diagram of a Semantic Data Transformation Module (SDTM) as a unified configurable architecture enabled Semantic Codec (SeCo) that employs the Task Specific Input Modification (TSIM) and the Task Specific Layer Modification (TSLM) modules for multi-task Semantic Information (SI) extraction in network nodes, in accordance with aspects of the disclosure;

FIG. 3 is a block diagram of a federated learning model aggregation process based local and global KB updates for multi-task semantic communication network, in accordance with aspects of the disclosure;

FIG. 4 is a diagram of the global KB-assisted distribution of SDTM NN models and TSMLCs for semantic communication source/destination SI extraction, in accordance with an illustrative diagram of the MTSC network nodes, in accordance with aspects of the disclosure;

FIG. 5 is a diagram of DS coordinated semantic transmission among ESs with local coordinator synchronization upon arrival of an ES transmission request, in accordance with aspects of the disclosure;

FIG. 6 is a diagram of a method of federated learning procedure for MTSC within which systems and methods disclosed herein may be implemented, in accordance with aspects of the disclosure;

FIG. 7 is a diagram of a semantic communication among network nodes within which systems and methods disclosed herein may be implemented, in accordance with aspects of the disclosure;

FIG. 8 is a diagram of a federated learning-assisted multi-task-semantic communications within which systems and methods disclosed herein may be implemented, in accordance with aspects of the disclosure;

FIG. 9 is a block diagram providing details of computing components in a computing device, in accordance with aspects of the disclosure; and

FIG. 10 is a system diagram of various hardware components and other features for use in accordance with aspects of the disclosure; and

FIG. 11 is a block diagram of various example system components for use in accordance with aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

The following includes definitions of selected terms employed herein. The definitions include various examples and/or forms of components that fall within the scope of a term and that can be used for implementation. The examples are not intended to be limiting.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area Network (CAN), Local Interconnect Network (LIN), among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

The term “operable connection,” as used herein, can include a connection by which entities are “operably connected,” is one in which signals, physical communications, and/or logical communications can be sent and/or received. An operable connection can include a physical interface, a data interface and/or an electrical interface.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The detailed description set forth below in connection with the appended drawings is intended as a description of various configurations and is not intended to represent the only configurations in which the concepts described herein can be practiced. The detailed description includes specific details for the purpose of providing a thorough understanding of various concepts. However, it will be apparent to those skilled in the art that these concepts can be practiced without these specific details. In some instances, well known structures and components are shown in block diagram form in order to avoid obscuring such concepts.

Several aspects of certain systems will now be presented with reference to various example systems and methods. These systems and methods will be described in the following detailed description and illustrated in the accompanying drawings by various blocks, modules, components, circuits, steps, processes, algorithms, etc. (collectively referred to as “elements”). These elements can be implemented using electronic hardware, computer software, or any combination thereof. Whether such elements are implemented as hardware or software depends upon the particular application and design constraints imposed on the overall system.

By way of example, an element, or any portion of an element, or any combination of elements can be implemented with a “processing system” that includes one or more processors. One or more processors in the processing system can execute software. Software shall be construed broadly to mean instructions, instruction sets, code, code segments, program code, programs, subprograms, software modules, applications, software applications, software packages, routines, subroutines, objects, executables, threads of execution, procedures, functions, whether referred to as software, firmware, middleware, microcode, hardware description language, or otherwise.

Accordingly, in one or more aspects, the functions described can be implemented in hardware, software, firmware, or any combination thereof. If implemented in software, the functions can be stored on or encoded as one or more instructions or code on a computer-readable medium. Computer-readable media includes computer storage media. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

A Semantic Dynamic Task Management (SDTM) framework is disclosed that offers a configurable SeCo architecture for both source and destination nodes. This enables multi-modal, multi-task SI extraction for dynamic task assignments. The SDTM can be trained via FL in a distributed manner, employing network-wide weight updates based on diverse task-specific transmissions. This SDTM is facilitated by a shared KB that provides Task-Specific Input Modification (TSIM) and Task-Specific Layer Modification (TSLM) information. By employing FL with multiple Semantic Information Sources (SISs), the resilience of the employed SeCo against varying levels of semantic noise and ambiguity, as a result of a weight aggregation process that utilizes multiple localized training instances.

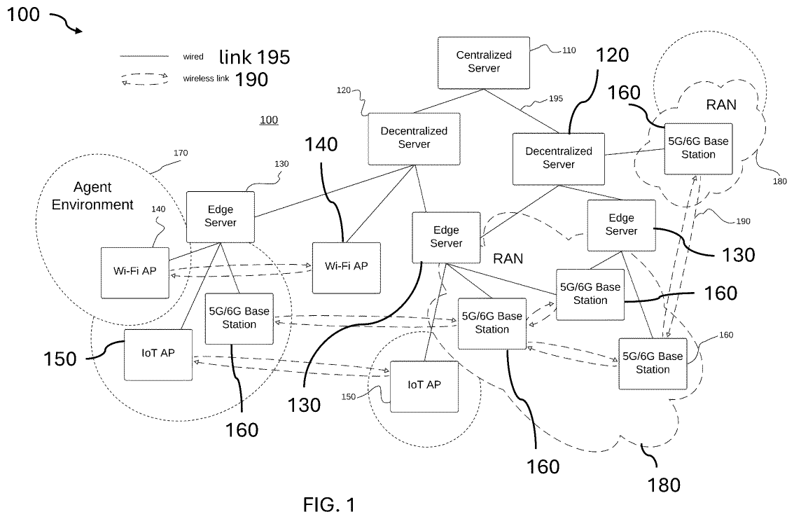

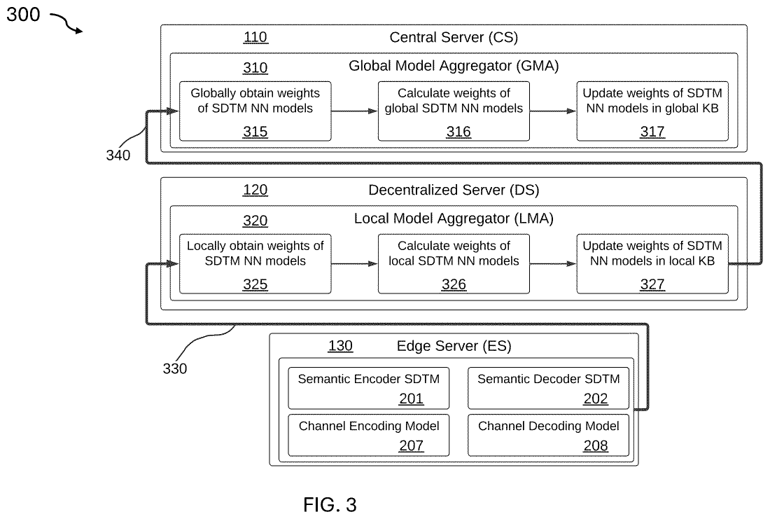

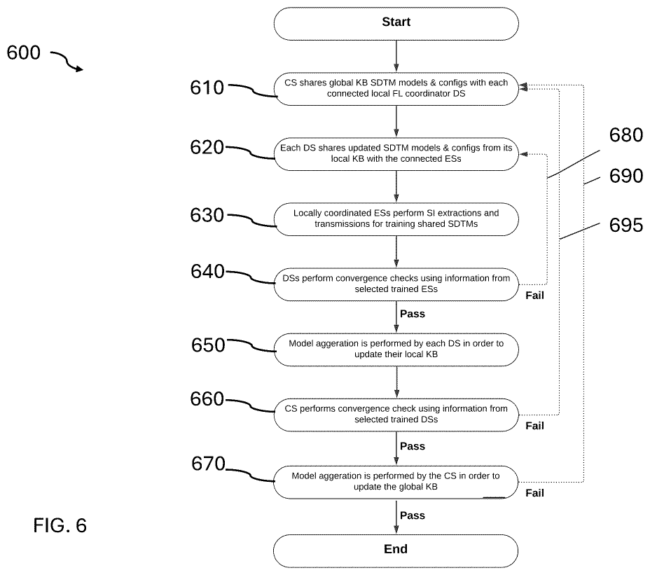

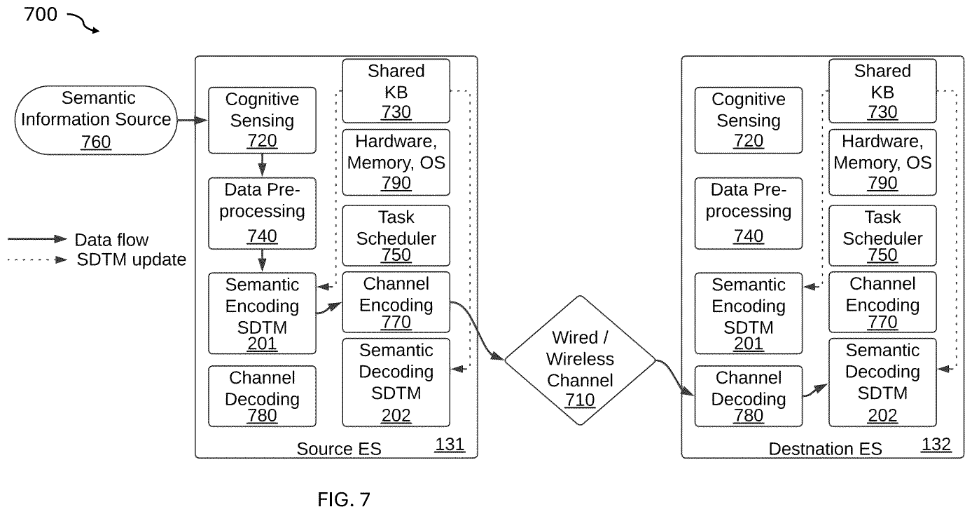

As illustrated in Figure FIG. 1, an example diagram of a semantic communication network 100 is shown, according to various aspects. In some aspects, a “network” can refers to a configuration of communicatively coupled programmable entities. A “programmable entity” can refer to an entity configured to perform computations and communications with other entities (also referred to herein as “nodes”) within a communication network, which may include wireless link(s) 190 and/or wired link(s) 195 and may include servers, infrastructure, computers, robots, and other communicatively coupled devices and entities. Semantic communication network 100 can comprise one or more of a variety of network nodes, including one or more centralized servers (“CSs”) 110, one or more decentralized servers (“DSs”) 120, one or more edge servers (“ESs”) 130, one or more 5G/6G Base Station (“BSs”) 160, one or more Wi-Fi Access Points (“APs”) 140, and one or more Internet of Things (“IoT”) APs 150. It should be understood that not all elements depicted in Figure FIG. 1 are required for the operation of semantic communication network 100, which can function with various combinations of the elements shown. Additional components and/or entities may be incorporated in semantic communication network 100 in various aspects. In some aspects, semantic communication network 100 may operate without one or more of the elements shown, including the federated learning system (e.g., a distributed learning and/or weight update as shown in FIG. 6 and associated description with respect to method 600). The semantic communication network 100 may include a federated learning system (e.g., see FIG. 6 and method 600, via a coordinator that initially distributes NN weights from a global KB or NN repository. FL participants are configured to store a shared model in a local KB for task specific or multi-task specific weight update(s) using training. Following a training procedure, participants can share the NN weights with a coordinator where the weights are aggregated for updating a global model) (see also FIG. 3 with a multi-tier weight aggregation with FL coordinators and FIG. 3 with multi-tier model weight distribution), multiple federated learning systems, or capabilities that support or interact with the federated learning system 600, thereby benefiting from the functionalities discussed herein. The federated learning system 600 can engage with other federated learning systems and/or servers within a broader architecture comprising multiple communication networks, as elaborated further below. Instances of federated learning systems 600 are applicable to any network capable of integrating the systems or methods described herein. The semantic communication network 100 may also incorporate one or more Radio Access Networks (RANs) 180 to facilitate semantic communication 700. The core network can include a User Plane Function (UPF) and enables data forwarding between a Radio Access Network (RAN) 180 and a DS 120, thereby ensuring that the architecture is compatible with 5G and 6G wireless systems. Additionally, semantic communication network 100 can be utilized by an agent environment 170, which comprises one or more connected programmable entities capable of and/or configured to execute AI functions or employ machine learning (ML) models. Numerous agent environments 170 can leverage semantic communication network 100 to request necessary semantic communication resources (e.g., see FIG. 7 and related description), thus benefiting from the functionality and principles discussed herein.

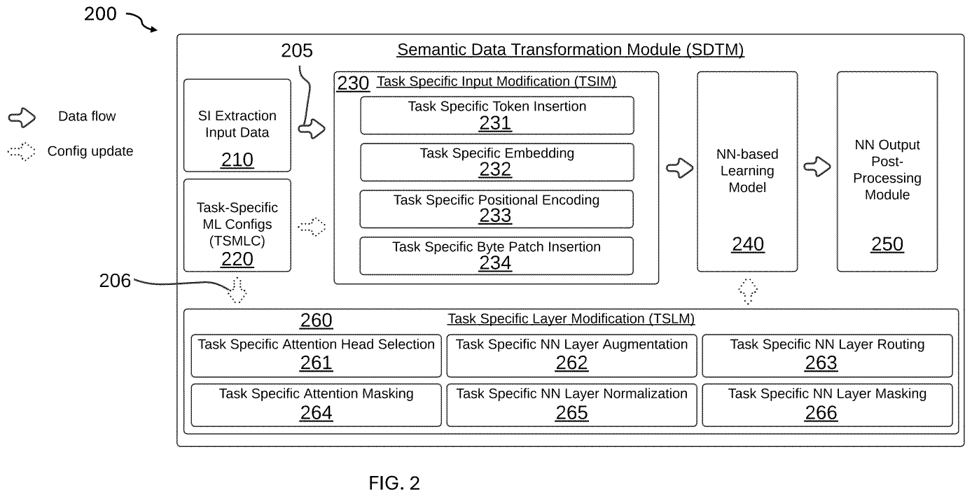

Semantic communication network 100 may feature a centralized server 110 responsible for the global management of a semantic-oriented communication-related Knowledge Base (KB). This KB can be stored in one or more memories and contains and/or comprises information for ML-related procedures. This can include essential information, such as procedures and/or protocols for updating neural network weights during training, sharing Semantic Codec (SeCo) architecture with edge server nodes 130, distributing semantic communication-related ML models (e.g., see NN-based Learning Model 240 of FIG. 2 and related description), configuring ML models (e.g., see Task-Specific ML Configurations (TSMLC) 220 of FIG. 2 and related description), modifying task-specific data inputs (e.g., see Task Specific Input Modification (TSIM) 230 of FIG. 2 and related description), adjusting task-specific ML model options (e.g., see Task Specific Layer Modification (TSLM) 260 of FIG. 2 and related description), and updating KBs through federated learning 600. Multiple centralized servers 110 or nodes with capabilities of centralized servers 110 can coexist in either a synchronized or unsynchronized manner to support or interact with the federated learning system 600, thus providing the functionalities described herein. The centralized server 110 can be communicatively coupled with at least one decentralized server 120 via one or more wired links 195 or wireless links 190, and/or combinations thereof. The decentralized server 120 may function as a local federated learning coordinator, managing multiple edge servers 130 to enable ML model training across geographically distributed and/or complex networks, thereby updating globally stored KBs and/or ML models stored in and/or accessible by the centralized server 110. In certain scenarios, the centralized server 110 may be communicatively coupled and/or otherwise connect directly to one or more edge servers 130, providing them with requested ML models (e.g. see NN-based Learning Model 240 of FIG. 2 and related description) and/or configurations (e.g., see TSMLC 220 of FIG. 2 and related description) without the need for relay nodes.

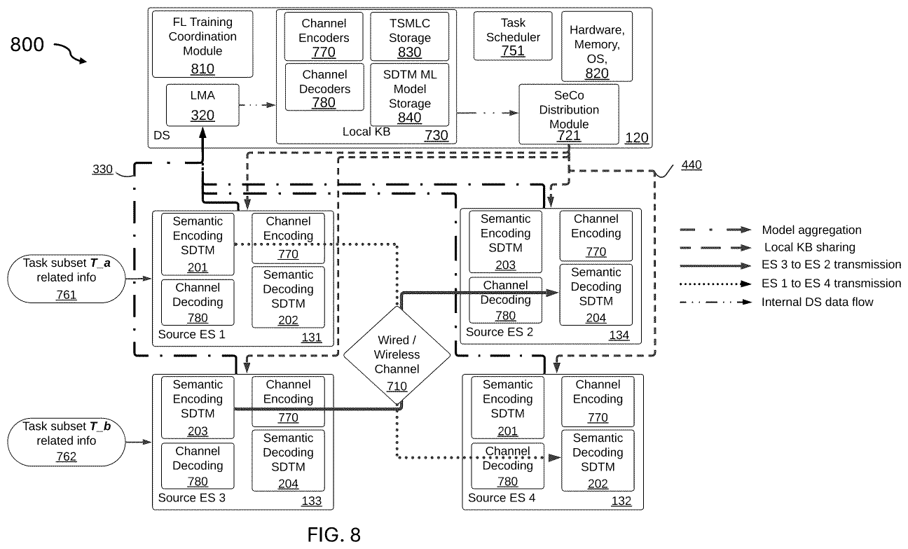

A decentralized server 120 may contain a Federated Learning (FL) training coordination module (e.g., see FL Training Coordination Module 810 of FIG. 8 and related description), which is responsible for selecting edge server(s) 130 to be utilized during task-specific SeCo training procedures for Multi-Task Semantic Communication (a). This process can be used to optimize transmissions based on various semantic and channel noise levels. FL training coordination module 810 can monitor various performance metrics related to semantic information (SI) during or after an ML training process, such as loss performance, accuracy of NN-based ML models employed by the source and/or destination SeCo Semantic Data Transmission Models (es), and other metrics). During local coordination of Federated Learning (FL) by decentralized servers 120, each DS 120 can utilize a Local Model Aggregator (LMA) (e.g., see LMA 320 of FIG. 3 and related description) to retrieve weights of, for, or related to machine learning models from local semantic encoder and decoder models (e.g., see calculate weights of local SDTM NN models 326 of FIG. 3 and related description). The LMA 320 can be configured to perform statistical aggregation for local models and updates the local models in the knowledge base (KB) using the computed weights (e.g., see Update weights of SDTM NN models in KB 327 of FIG. 3 and related description). A decentralized server 120 may comprise and/or contain one or more storage mechanisms in the form of a KB to manage and distribute channel encoders (e.g., see channel encoding 770 of FIG. 7 and related description), channel decoders (e.g., see channel decoding 780 of FIG. 7 and related description), Semantic Information (SI) encoding/decoding State Decision Transition Models (SDTMs) (e.g., see SDTM ML Model Storage 840 of FIG. 8 and related description), and Task-Specific Machine Learning Components (TSMLCs) (e.g., see TSMLC storage 830 of FIG. 8 and related description). Additionally, the decentralized server 120 is equipped with hardware (e.g., one or more processor(s)), memory, and an operating system (OS) (e.g., see Hardware, Memory OS, 820 of FIG. 8 and related description) to perform computations and host software programs. DS 120 can also include a task scheduler (e.g., see Task Scheduler 750 of FIG. 7 and related description) that organizes the distribution of ML-related KB content (e.g., see Shared KB 730 of FIG. 7 and related description) via the SeCo distribution module (e.g., see 721 of FIG. 8 as part of an FL coordinator).

In some aspects, an edge server 130 may include various modules. Examples of modules included in ES 130 include modules for semantic encoding (e.g., see Semantic Encoding SDTM 201 of FIG. 7 and related description), channel encoding (e.g., see channel encoding 770 of FIG. 7 and related description), channel decoding (e.g., see channel decoding 780 of FIG. 7 and related description), and semantic decoding (e.g., see Semantic Decoding SDTM 202 of FIG. 7 and related description). Certain aspects may feature a subset of these functionalities, rather than all functionalities. Edge server 130 can facilitate wired and/or wireless physical channel transmissions via one or more networking components and can employ cognitive sensing to gather input observation data from one or more semantic information sources (e.g., see Semantic Information Source(s) 760 of FIG. 7 and related description). Collected observation data can be preprocessed by a data pre-processing module (e.g., see data pre-processing 740 of FIG. 7 and related description) and then forwarded to the semantic encoding SDTM (e.g., see semantic encoding SDTM 201 of FIG. 7 and related description) for SI extraction, based on a previously shared and stored task-specific KB (e.g., see shared KB 730 of FIG. 7 and related description). ES 130 can also include hardware (e.g., one or more processor(s)), memory, and an OS (e.g., see hardware, memory, and OS 790 of FIG. 7 and related description) to carry out computations, along with a task scheduler (e.g., see task scheduler 750 of FIG. 7 and related description) for organizing semantic or ML-related transmissions. Multiple versioned models and configurations related to task-specific semantic transmissions 700 can be stored in memory (e.g., see hardware, memory, OS 790 of FIG. 7 and related description) of ES 130, thereby eliminating a need to request SeCo-related data each time FL training results may be unsuitable for operation due to conflict with performance constraints and/or unsatisfactory training performance. In some aspects this lack of suitability for operation can also be described as failing to pass one or more convergence checks as shown in 640 and 660.

Referring to FIG. 2, a neural network-based Semantic Communication (SeCo) framework is shown, in particular, a Semantic Data Transformation Module (SDTM) 200. SDTM 200 can be configured to perform functionalities such as Semantic Information (SI) extraction, semantic encoding, and decoding (e.g., as shown in FIG. 7, information can be encoded (by semantic encoding and/or channel encoding) and transmitted by a transmitter to a receiver. The receiver can perform channel decoding and use semantically encoded information (i.e., data) and/or perform channel and/or semantic decoding before using the information) during multi-task semantic communications. SDTM 200 can utilize SI extraction input data 210 to enhance data processing for specific tasks through a Task-Specific Input Modification Module (TSIM) 230. SI Extraction input data 210 can be either single or multi-modal and may be pre-processed before being utilized by SDTM 200. TSIM 230 can modify the SI extraction input data 210 by executing one or more of various operations, including Task-Specific Token Insertion 231, Task-Specific Embedding 232, Task-Specific Positional Encoding 233, or Task-Specific Byte Patch Operations 234, to tailor SI extraction input data 210 for a defined set of semantic tasks. The modified input for semantic communication can be sent or forwarded to one or more neural network (NN)-based learning models 240, which perform one or more non-linear function approximations or input-output mappings. An output from the NN-based learning model(s) 240 can undergo additional processing by an NN-output post-processing module 250, which can apply one or more linear or non-linear transformations. During semantic encoding or decoding processes within SDTM 200, the NN architecture can be adjusted by a Task-Specific Layer Modification (TSLM) module 260. TSLM module 260 can be configured to perform one or more of several operations, such as Task-Specific Attention Head Selection 261, Task-Specific Neural Network Layer Augmentation 262, Task-Specific NN Layer Routing 263, Task-Specific Attention Masking 264, Task-Specific NN Layer Normalization 265, and Task-Specific NN Layer Masking 266. Operations from one or both of TSIM 230 and TSLM 260 can be conducted based on previously configured or shared Task-Specific ML Configurations (TSMLC) 220, either during or prior to the semantic communications.

FIG. 3 illustrates a method 300 of aggregating a federated learning model, particularly by updating weights of neural network/machine learning (NN/ML) models for multi-task semantic communications. In various aspects, updates of NN/ML models can be conducted either locally or globally in a hierarchical manner. Locally stored models can be distributed in a Knowledge Base (KB) in one or more edge servers 130 and shared periodically and/or aperiodically as shown by arrow 330 with a local model coordinator 320 of one or more DS 120. The locally aggregated models can then be shared periodically and/or aperiodically as show by arrow 340 with a global model aggregator 310 of one or more CS 110, which can act as a coordinator. Local Model Aggregator (LMA) 320 of DS 120 can facilitate a model update by acquiring locally distributed SDTM NN models (including weights) from Edge Servers (ESs) 1230 at block 325. LMA 320 can perform calculate weights of local SDTM NN models in block 326 (e.g., by performing statistical weight aggregation on locally obtained SDTM neural network weights). Next, LMA 320 can update weights SDTM NN models (e.g., local SeCo SDTM models) of the DS KB at block 327. Similarly, within CS 110, a Global Model Aggregator (GMA) 310 executes a model update by obtaining globally distributed SDTM NN weights from one or more DSs at block 315. GMA 310 can conduct statistical weight aggregation on these globally obtained SDTM neural network weights by calculating weights of the global SDTM NN models at block 316. Next, GMA 310 can update weights of SDTM NN models in global KB at block 317, for example by updating global SeCo information of the CS KB using the computed neural network weights.

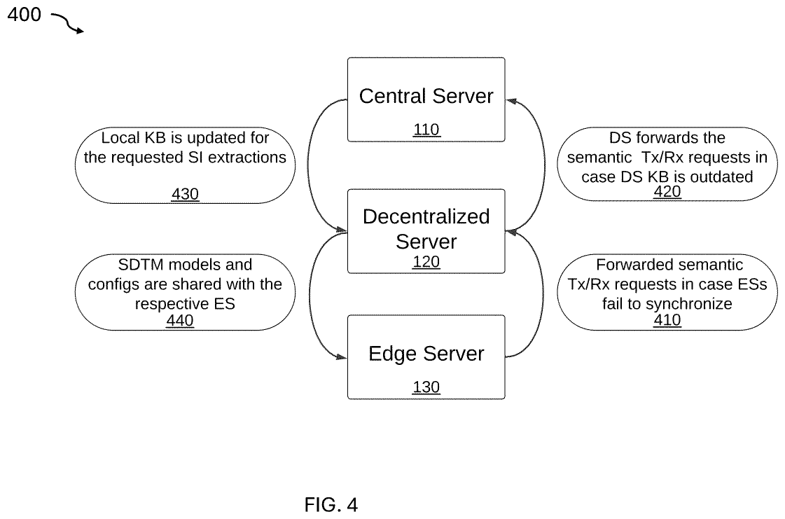

FIG. 4 is a diagram 400 showing a distribution of local and global SDTM neural network models and TSMLC, according to various aspects including multi-task semantic communication (MTSC) network nodes. If edge servers (ESs) (e.g., ESs 130) involved in a semantic transmission fail to synchronize or communicate directly with one another, model sharing process can initiate with a transmission/reception request from an edge server (ES) 130 to a connected local coordinator (e.g., a DS 120) for specific tasks, as shown at block 410 where semantic transmission and/or reception request(s) can be sent to DS 120 in the case where ESs 130 fail to synchronize. If a requested machine learning (ML) model and task-specific configurations are available in the DS KB, DS 120 can share the requested information with the ES 130. In other words, at block 440 DS 120 can share SDTM models and configurations with the respective ES 130. If DS 120 does not possess the requested models or configurations in its local KB, DS 120 can forward the semantic transmission and/or reception requests in the case where DS 120 KB is outdated in block 420 (i.e., the task-specific requests from the ES 130 are sent to the global coordinator (CS) 110). CS 110 can update a local KB for the requested SI extractions at block 430 (i.e., CS 110 shares the requested model and configurations from its global KB with the local coordinator DS 120 of the requesting ES 130) which further relays the information to the ES 130 and its transmission target for multi-task semantic communications (i.e., DS performs block 440). In this framework, DSs 120 serve as initial responders for the requested information from ESs 130, rather than allowing direct access to the global coordinator CS 110. This approach helps prevent bottlenecks at CS 110 for ES 130 semantic transmission requests.

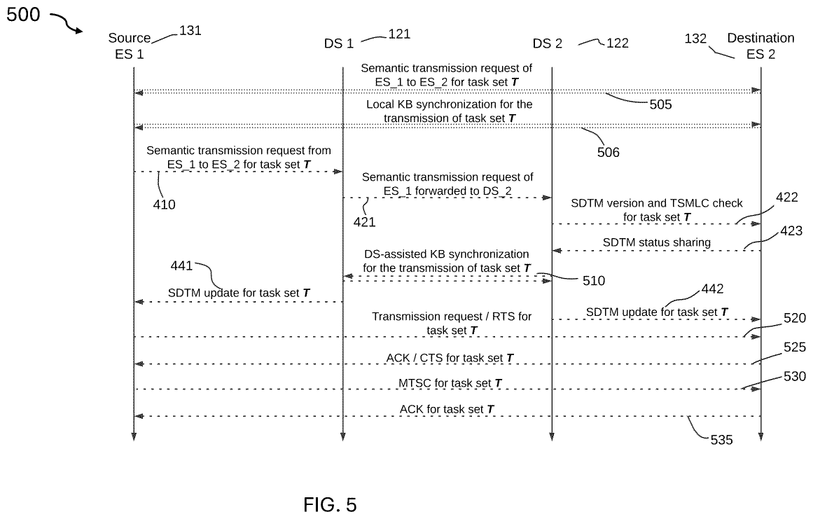

FIG. 5 is a message sequence diagram 500 showing locally coordinated federated learning (FL) in the context of multiple distributed servers (DSs)(e.g., DS 1 121 and DS 2 122), where a transmission (Tx) server (e.g., source ES 1 131 and reception (Rx) edge server (e.g., destination ES 2 132) are communicatively coupled to separate DSs (e.g., DS 1 121 and DS 2 122), according to various aspects. In the aspect shown, source edge server ES 1 131, may directly contact edge server ES 2 132 with a semantic transmission request for a specific set of tasks in transmission(s) 505. If the source and destination ESs 131, 132 are directly reachable by one another, ESs 131, 132 can initiate a local knowledge base (KB) synchronization procedure in transmission(s) 506. If ESs 131, 132 are unable to complete the requested transmission, edge server ES 1 131 can share the semantic communication request with its local coordinator DS 1 121 for task set T via transmission 410. The source DS 1 121 can inform the destination DS 2 122 to synchronize the source and destination knowledge bases (KBs) for the semantic transmission. For example, this can be accomplished by semantic transmission request ES 1 being forwarded from DS 1 121 to DS 2 122 at transmission 422. The notified destination DS 2 122, then requests the Semantic Data Transmission Model (SDTM) version and Task-Specific Machine Learning Configuration ( ) information in a check for task set T at transmission T to ES 2 132 in transmission 422 stored in destination ES's 122 KB. Following this, SDTM status sharing at transmission 423 from the destination ES 2 132 can be communicated to the responsible destination DS 2 122. Upon receiving the requested SeCo SDTM information, local coordinator DSs 121, 122 can initiate and perform a DS-assisted KB synchronization process for the transmission of task set T at transmission 510, sharing trained machine learning model specifications and configurations with each other. If necessary, the DSs 121, 122 share KB updates for the specified task set with their respective ESs 131, 132 at transmissions 441, 442, respectively by sending SDTM update for task set T. With the shared KB updates and completed synchronization procedures, the source ES 131 performs Semantic Information (SI) extraction and sends a transmission request, or Request-to-Transmit (a), to the destination ES for the requested task set T at transmission 520. If available, the destination ES 132 responds with an acknowledgment, or Clear-to-Send m), to the source ES 131 at transmission 525. Subsequently, the source ES 131 initiates the Multi-Task Semantic Coordination (MCTS) for the requested task set T at transmission 530, and the transmission window is finalized with an acknowledgment (ACK) from the destination ES 132 to the source ES 131 at transmission 535.

FIG. 6 illustrates a method 600 of a federated learning procedure for MCTS. The federated learning process begins with a CS sharing a knowledge base (KB) SDTM models and configurations update to the each connected, available FL coordinator DS via wired or wireless connection at block 610 (e.g., see 430 of FIG. 4 and associated description for additional detail). Shared CS KB includes the necessary pairs of SeCo SDTM models (e.g., see 240 of FIG. 2 and related description) and configurations (e.g., see 220 of FIG. 2 and associated description) for local FL coordination. At block 440 each DS shares the updated SDTM models and configurations from its local KB with its connected edge servers (ESs) for use in training and weight update procedures related to MCTS 620 (e.g., see 440 of FIG. 4 and associated description for additional detail). Subsequently, at step 630 the DS coordinates the ESs to perform MCTS using the coupled SeCos and loss functions to train and update the local SeCo models (e.g., see 500 of FIG. 5 and associated description for additional detail). After the training process, the DS conducts convergence checks using information from the ESs 640. If the training performance is unsatisfactory, the DS can re-share models and/or configurations with the ESs to repeat the training process via 680. Following the convergence checks, each local coordinator DS performs model aggregation to update the locally stored KB 650 (e.g., see 330 of FIG. 3 and associated description for additional detail). The CS then conducts convergence checks using information from the DSs to determine whether the locally aggregated machine learning/neural network (ML/NN) models can be utilized in the global model aggregation and KB update 660. If the performance of the locally stored models is deemed insufficient for a global KB update, the CS can reinitialize the training process by sharing the global KB via 695. In training episodes where the performance of the locally stored models meets the required standards, the global KB is updated by the CS global model aggregator (GMA) 670 (e.g., see 340 of FIG. 3 and associated description for additional detail), potentially leading to another training episode via 690.

FIG. 7 shows a diagram 700 of multi-task semantic communication utilizing a single Semantic Information Source (SIS) in accordance with various aspects. As shown, a source ES node 131 can receive information (e.g., from Semantic Information Source at block 760) through cognitive sensing block 720 from the SIS before initiating the multi-task semantic communication. The source ES performs preprocessing on the single-modal or multi-modal data to prepare the observations for Semantic Information (SI) extraction in data pre-processing block 740. Source ES 131 can then conducts semantic encoding using the SeCo SDTM architecture block 201 followed by channel encoding via the channel encoder block 770. Upon transmission over the physical channel block 710, the receiving destination ES 132 first performs channel decoding through the channel decoder block 780, and subsequently extracts the SI using the semantic decoder SDTM block 202 which has been previously linked in the shared Knowledge Base (KB) block 730. The output from the SI extraction in the destination SeCo SDTM can either be utilized directly by an application or forwarded to another network node.

FIG. 8 shows a diagram 800 of federated learning-assisted multi-task semantic communications that employs multiple SISs, within which the systems and methods disclosed herein may be implemented, in accordance with various aspects. In some aspects, diverse synchronized and/or asynchronous ES semantic transmissions can coexist within a locally coordinated subnetwork of a Distributed System (DS). While an ES 131 transmits semantic information to another ES 132 using SIS observations for a task set T_a at block 761, another ES 133 can simultaneously transmit semantic information to its own destination 134 using SIS observations for a different task set T_b at block 762. Prior to semantic transmissions or federated learning training for multiple tasks, the DS shares the necessary machine learning (ML) model weights and TSMLC with the encoder and decoder ESs from its local KB at block 440. If the training with multiple SIS observations is successful, the DS 120 can perform local weight aggregation, obtaining model weights from the node KBs involved in the multi-task semantic communication (MTSC) process at 330.

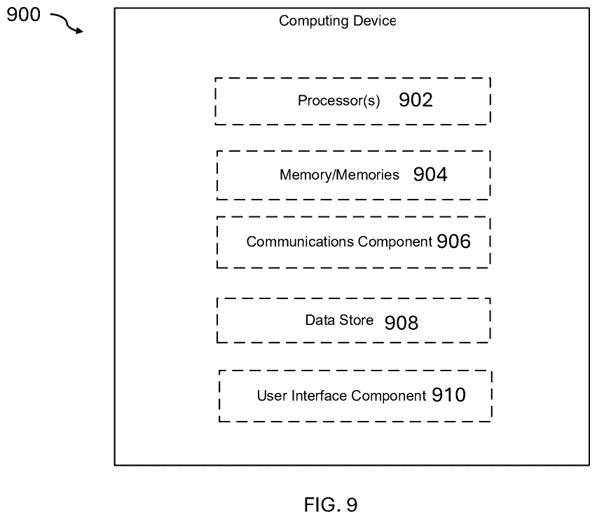

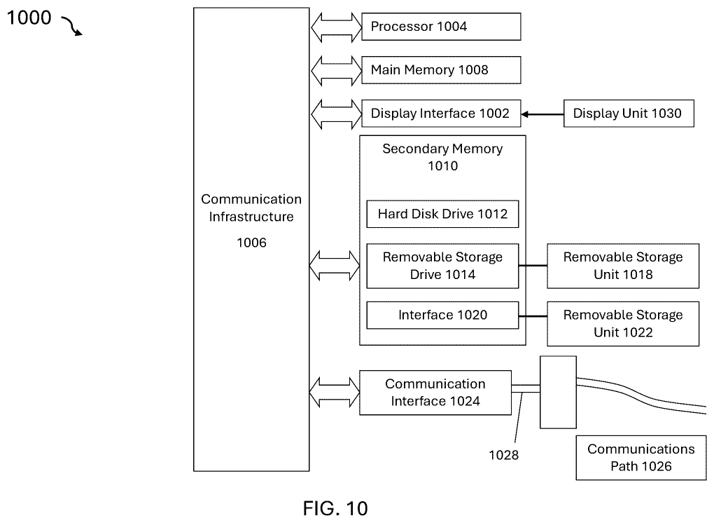

Aspects of the present disclosure may be implemented using hardware, software, or a combination thereof and can be implemented in one or more computer systems or other processing systems. In one aspect, the disclosure is directed toward one or more computer systems capable of carrying out the functionality described herein. An example of such a computer system 900 is shown in FIG. 9. Another example of such a computer system 1000 is shown in FIG. 10.

FIG. 9 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 900 is shown in FIG. 9. As shown, FIG. 9 is a system diagram providing details of computing components in a computing device 900 that may implement all or a portion of one or more components in one or more of the servers (e.g., CS, DS, or ES) or any other component described above, according to some aspects. The computing device 900 may include one or more processors 902 which may be configured to execute or implement software, hardware, and/or firmware modules that perform any functionality described above with reference to one or more components in an addressable device.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 902 may include a micro-controller and/or may include a single or multiple set of processors or multi-core processors. Moreover, the one or more processors 902 may be implemented as an integrated processing system and/or a distributed processing system. The computing device 900 may further include one or more memories 904, such as for storing local versions of applications being executed by the one or more processors 902, related instructions, parameters, etc. The one or more memories 904 may include a type of memory usable by a computer, such as random access memory (RAM), read only memory (ROM), tapes, flash drives, magnetic discs, optical discs, volatile memory, non-volatile memory, and any combination thereof. Additionally, the one or more processors 902 and the one or more memories 904 may include and execute an operating system executing on the one or more processors 902, one or more applications, display drivers, etc., and/or other components of the computing device 900.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 900 may include a communications component 906 that provides for establishing and maintaining communications with one or more other devices, parties, entities, etc., utilizing hardware, software, and services. The communications component 906 may carry communications between components on the computing device 900, as well as between the computing device 900 and external devices, such as devices located across a communications network and/or devices serially or locally connected to the computing device 900. For example, the communications component 906 may include one or more buses, and may further include transmit chain components and receive chain components associated with a wireless or wired transmitter and receiver, respectively, operable for interfacing with external devices.

In some optional aspects, the computing device 900 may additionally include a data store 908, which can be any suitable combination of hardware and/or software, that provides for mass storage of information, databases, and programs. For example, the data store 908 may be or may include a data repository for applications and/or related parameters not currently being executed by the one or more processors 902. In addition, the data store 908 may be a data repository for an operating system, application, display driver, etc., executing on the one or more processors 902, and/or one or more other components of the computing device 900.

Also, in some optional aspects, the computing device 900 may additionally include a user interface component 910 operable to receive inputs from a user of the computing device 900 and further operable to generate outputs for presentation to the user (e.g., via a display interface to a display device). The user interface component 910 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 910 may include one or more output devices, including but not limited to a display interface, a speaker, a haptic feedback mechanism, a printer, any other mechanism capable of presenting an output to a user, or any combination thereof.

FIG. 10 presents an example system diagram of various hardware components and other features, for use in accordance with an aspect of the present disclosure. Aspects of the present disclosure can be implemented using hardware, software, or a combination thereof and can be implemented in one or more computer systems or other processing systems. In one example variation, aspects described herein can be directed toward one or more computer systems capable of carrying out the functionality described herein. An example of such a computer system 1000 is shown in FIG. 10.

Computer system 1000 includes one or more processors, such as processor 1004. The processor 1004 is connected to a communication infrastructure 1006 (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system 1000 can include a display interface 1002 that forwards graphics, text, and other data from the communication infrastructure 1006 (or from a frame buffer not shown) for display on a display unit 1030. Computer system 1000 also includes a main memory 1008, preferably random access memory (RAM), and can also include a secondary memory 1010. The secondary memory 1010 can include, for example, a hard disk drive 1012 and/or a removable storage drive 1014, representing a floppy disk drive, a magnetic tape drive, an optical disk drive, etc. The removable storage drive 1014 reads from and/or writes to a removable storage unit 1018 in a well-known manner. Removable storage unit 1018, represents a floppy disk, magnetic tape, optical disk, etc., which is read by and written to removable storage drive 1014. As will be appreciated, the removable storage unit 1018 includes a computer usable storage medium having stored therein computer software and/or data.

In alternative aspects, secondary memory 1010 can include other similar devices for allowing computer programs or other instructions to be loaded into computer system 1000. Such devices can include, for example, a removable storage unit 1022 and an interface 1020. Examples of such can include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, which allow software and data to be transferred from the removable storage unit 1022 to computer system 1000.

Computer system 1000 can also include a communications interface 1024. Communications interface 1024 allows software and data to be transferred between computer system 1000 and external devices. Examples of communications interface 1024 can include a modem, a network interface (such as an Ethernet card), a communications port, a Personal Computer Memory Card International Association (PCMCIA) slot and card, etc. Software and data transferred via communications interface 1024 are in the form of signals 1028, which can be electronic, electromagnetic, optical or other signals capable of being received by communications interface 1024. These signals 1028 are provided to communications interface 1024 via a communications path (e.g., channel) 1026. This path 1026 carries signals 1028 and can be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1014, a hard disk installed in hard disk drive 1012, and signals 1028. These computer program products provide software to the computer system 1000. Aspects described herein can be directed to such computer program products.

Computer programs (also referred to as computer control logic) are stored in main memory 1008 and/or secondary memory 1010. Computer programs can also be received via communications interface 1024. Such computer programs, when executed, enable the computer system 1000 to perform various features in accordance with aspects described herein. In particular, the computer programs, when executed, enable the processor 1004 to perform such features. Accordingly, such computer programs represent controllers of the computer system 1000.

In variations where aspects described herein are implemented using software, the software can be stored in a computer program product and loaded into computer system 1000 using removable storage drive 1014, hard disk drive 1012, or communications interface 1020. The control logic (software), when executed by the processor 1004, causes the processor 1004 to perform the functions in accordance with aspects described herein as described herein. In another variation, aspects are implemented primarily in hardware using, for example, hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

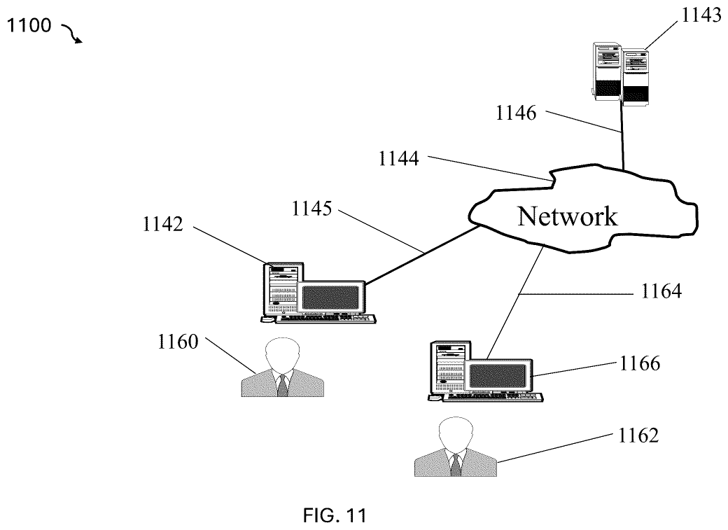

FIG. 11 is a block diagram of various example system components, in accordance with an aspect. FIG. 11 shows a communication system 1100 usable in accordance with various aspects described herein. The communication system 1100 includes one or more accessors 1160, 1162 (also referred to interchangeably herein as one or more “users”) and one or more terminals 1142, 1166 (also referred to herein as one or more “user device(s)”). For example, terminals 1142, 1166 may include or be communicatively coupled with one or more of the servers described herein, remote devices, and/or the like. In one aspect, data for use in accordance with aspects described herein is, for example, input and/or accessed by accessors 1160, 1162 via terminals 1142, 1166, such as personal computers (PCs), minicomputers, mainframe computers, microcomputers, telephonic devices, or wireless devices, such as personal digital assistants (“PDAs”) or a hand-held wireless device coupled to a server 1143, such as a PC, minicomputer, mainframe computer, microcomputer, or other device having a processor and a repository for data and/or connection to a repository for data, via, for example, a network 1144, such as the Internet or an intranet, and couplings 1145, 1146, 1164. The couplings (also referred to herein as “link(s)”) 1145, 1146, 1164 include, for example, wired, wireless, or fiberoptic links, and combinations thereof. In another example variation, the methods and systems in accordance with aspects described herein can operate in a stand-alone environment, such as on a single terminal.

The aspects discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

In accordance the various aspects described herein, a system can comprise a Centralized Server (CS) that manages a global Knowledge Base (KB) within a network for multi-task Semantic Information (SI) extraction using Semantic Codes (Secos) that facilitates effective communication during transmissions; at least one Decentralized Server (DS) that oversees the coordination of local KBs including neural network (NN) model weights and Task-Specific Machine Learning Configurations (TSMLCs) for source and destination SeCos, in line with federated learning (FL) weight updates, training, and semantic transmission procedures; and at least one Edge Server (ES) responsible for distributing and applying either local or global SeCo-based semantic encoding or decoding machine learning models, which are utilized during task-specific semantic transmissions.

Aspects can also include centralized and decentralized coordination, comprising systems and methods of integrating a Centralized Server (CS), with Decentralized Servers (DSs), and Edge Servers (ESs) that provides a structured approach to model training, updates, and semantic transmissions. This architecture promotes decentralization, enables localized processing, reduces and/or avoids bottlenecks, and reduces and/or minimizes latency in semantic communications.

Aspects can also include methods of federated learning assisted multi-task semantic communications, comprising one or more of:

Semantic Encoding: At a transmitter (e.g., a transmitter ES) that can be performed after coordinated distribution of at least one task-related Semantic Data Transformation Module (SDTM) NN weights and TSMLCs from the CS KB or one or more DS KBs. Here, the input data, prepared through cognitive sensing and pre-processing operations, is modified using at least one Task Specific Input Modification (TSIM) operation, followed by encoding correlated task information with at least one NN-based ML model, which is further modified using at least one Task Specific Layer Modification (TSLM) operation based on TSMLC, and concluded with at least one task-related NN output post-processing operation.

Channel Encoding (CE): At a transmitter (e.g., a transmitter ES), uses a deterministic computational block or a task-specific channel encoding ML model optimized to effectively mitigate channel or semantic noise.

Channel Decoding (CD): At a receiver (e.g., a receiver ES), employs a deterministic computational block or a task-specific channel decoding ML model, which can also be optimized to address channel or semantic noise.

Semantic Decoding: At a receiver (e.g., a receiver ES), following channel decoding, a task-specific SI can be decoded by at least one SDTM SeCo block, which is optimized for the semantic encoder SeCo SDTM based on a shared KB, utilizing task-specific NN weights and TSMLC rules for TSIM and TSLM operations.

Aspects can also include Federated Learning Integration, whereby disclosed systems enable collaborative model training while ensuring data privacy, which can be essential in many 5G and/or 6G applications.

Aspects can also include Direct Application of Decoded Information, including methods according to Centralized and Decentralized Coordination as described above that specify that task-specific SI decoded by the decoder SeCo SDTM, utilizing at least one ML model, can be directly applied in an application, ensuring seamless integration into practical use cases

Aspects can also include Unified ML-based Architecture for Multiple Task-Related Optimizations, that are operable to eliminate computation and communication resource overhead in the presence of multiple dynamic task definitions. Methods of federated learning assisted multi-task semantic communications can comprise a replicable Semantic Data Transformation Module (SDTM) Semantic Codec (SeCo) architecture that utilizes TSMLCs for task-specific SI extraction operations, wherein the SDTM can perform TSIM and TSLM with an NN-based ML model based on a shared KB during training and semantic communication utilization. Consequently, this approach reduces/eliminates the complexity of managing multiple models, which would otherwise lead to increased computational and storage overhead and degraded latency performance. Furthermore, task correlations and meta-features are implicitly learned by at least one NN model employed by the SDTM, enabling correlated multi-task SI extraction. Aspects can also include Dynamic Task Management, including systems and methods that dynamically update a task list in response to both external and internal requests, ensuring that the employed systems remain responsive to evolving communication needs.

Aspects can also include Multi-Modality in Input Data, including methods that accommodate input data for semantic transmission that includes at least one type of modality, providing versatility in data handling and communication. The ability to manage various modalities is a significant advantage, as it expands the employed system's applicability. The TSIM and NN output processing operations can identify the modality of SDTM input and output data during both training and transmission processes. These methods can provide seamless integration of diverse data modalities, enhancing semantic transmission. This capability employs advanced AI and machine learning applications, enabling the processing of text, images, and audio concurrently or semi-concurrently. The system's versatility provides ubiquity across applications such as natural language processing and computer vision, underscoring its adaptability to various data types. The TSIM model and neural network (NN) exhibit sophisticated processing by identifying the modality of SDTM input and output data during both training and transmission and represents a significant advancement in data handling. The proposed methods offers seamless management of multiple modalities.

Aspects can also include Diverse Neural Network and ML Model Architecture Applicability for Various 5G/6G Agent Environments, including selection of ML models based on task characteristics and the dynamics of the deployed network. The ML models utilized by the SDTM SeCo architecture for SI extraction can vary. This method allows for the use or training of different neural network (NN)-based ML model architectures tailored to various task specific encoding or decoding tasks. This adaptability enhances the system's efficiency and effectiveness in managing a range of diverse tasks. The flexibility to employ various neural network architectures across different environments and application domains is a notable advantage. The strategic utilization of diverse neural architectures for specialized encoding and decoding tasks enhances performance and efficiency and thereby promotes network optimization.

Aspects can also include Adaptive Model Selection Mechanism(s), including systems that dynamically select a most appropriate machine learning model in edge servers for SI extraction based on the shared knowledge base and task-specific ML configurations, ensuring optimal performance for each semantic communication task and modality.

Aspects can also include Cross-Task Knowledge Transfer, including methods that facilitates knowledge transfer between different tasks by leveraging shared parameters and learned representations from previously trained models, thereby enhancing the efficiency and accuracy of semantic communications across varied tasks.

Aspects can also include Decentralized Model Training, including systems and methods that that allows decentralized servers (DSs) to independently train local models using locally available data while periodically synchronizing with the centralized server (CS) to update global model parameters, promoting data privacy and reducing the need for data centralization.

Aspects can also include Federated Learning Performance Monitoring and Adjustment, including systems and methods operable to monitor communication performance metrics (e.g., latency, throughput, error rates) and SI extraction performance metrics (e.g. model loss function, convergence rates) automatically adjusting local or global model and parameter distribution to maintain optimal communication efficacy.

Aspects can also include Scalability to Support Large-Scale Networks, whereby systems and methods provide a framework designed to efficiently scale the federated learning architecture to support a large number of decentralized servers and edge servers, ensuring consistent performance and model accuracy across extensive networks.

Aspects can also include Multi-Server Coordination for Semantic Transmission, including one or more coordination mechanisms that enables multiple decentralized servers (DSs) and/or edge servers (ESs) to collaborate during semantic transmission, optimizing resource allocation and reducing interference among concurrent communications.

Aspects can also include Interoperability with Legacy Systems, including systems and methods that ensure compatibility and seamless integration with existing legacy communication systems, allowing for gradual transition and adoption of federated learning-assisted semantic communication techniques without complete system overhauls.

In some aspects, a hierarchical, AI-native architecture for federated learning (FL)-enhanced multi-task semantic communications can comprise: a Central Server (CS) acting as the global orchestrator and maintaining a dynamic Knowledge Base (KB); one or more Decentralized Servers (DSs) interfacing with the CS, and one or more Edge Servers (ESs) deployed at the network periphery.

In various aspects, the dynamic KB maintained by the CS can store one or more of: versioned neural network (NN) model weights, task-adaptive semantic encoding/decoding (SeCo) configurations, and federated aggregation policies for multi-task Semantic Information (SI) extraction and transmission.

In various aspects each of the one or more DSs can be configured to manage one or more of: localized KBs with task-specific machine learning configurations (TSMLCs), adaptive training loops for SeCo architectures, optimizing FL-driven weight updates, and cross-layer coordination of semantic transmission procedures between edge nodes.

In various aspects each of the one or more ESs can be configured to execute one or more of: distributed inference via SeCo-based encoders/decoders, Real-time adaptation of global or local NN models for task-aware semantic transmissions, and low-latency processing for radio access networks (RANs) with FL-compliant privacy preservation.

In some aspects, the hierarchical, AI-native architecture for federated learning (FL)-enhanced multi-task semantic communications can have SeCos that further comprise: Semantic Data Transformation Modules (SDTMs) for dynamic encoding and decoding of semantic information; and a hybrid coordination framework comprising the Centralized Server (CS), one or more Decentralized Servers (DSs), and one or more Edge Servers (ESs).

In various aspects, the hybrid coordination framework can be configured to enable one or more of: structured model training and updates, localized semantic processing to minimize latency, bottleneck mitigation through distributed computational load balancing, and optimized semantic transmissions via adaptive centralized-decentralized synchronization.

In some aspects, a method for federated learning (FL)-assisted multi-task semantic communication (MTSC), comprises: global knowledge distribution, distributed federated learning, edge-aware semantic extraction, and convergence and knowledge extraction.

In various aspects, global knowledge distribution can comprise: transmitting, from a centralized server (CS), a global knowledge base (KB) comprising one or more of: Semantic Data Transformation Models (SDTMs) with task-specific neural network (NN) weights, Task-Specific Modification Logic Configurations (TSMLCs) for adaptive layer adjustments, and Optimized configurations for semantic-channel encoding/decoding.

In various aspects, Distributed Federated Learning can comprise: updating, at one or more local FL-distributed servers (DSs), SDTMs and TSMLCs via one or more of: Task-Specific Input Modification (TSIM) for dynamic input adaptation, and Task-Specific Layer Modification (TSLM) for context-aware NN refinement.

In various aspects, Edge-Aware Semantic Extraction can comprise: deploying the updated SDTMs and TSMLCs to edge servers (ESs). Deploying can further comprise one or more of: cognitive semantic encoding, where input data is transformed via TSIM, encoded using SDTMs, and fine-tuned via TSLM, noise-resilient transmission. Noise-resilient transmission can comprise employing one or more of deterministic channel encoding and/or decoding, and Task-specific ML models optimized for semantic/channel noise mitigation.

Convergence & Knowledge Aggregation can comprise: validating model convergence at the DSs using feedback from selected ESs, and Aggregating refined semantic knowledge into the global KB for iterative FL optimization.

In some aspects, a method for efficient multi-task semantic communication leveraging a single Semantic Information Source (SIS), can comprise: receiving and processing; intelligent semantic encoding; robust channel encoding; seamless transmission; and precision decoding.

In various aspects, receiving and processing can comprise: capturing SIS information at a source Edge Server (ES) with high-fidelity cognitive sensing to extract deep semantic features.

In various aspects, intelligent semantic encoding can comprise: transforming SIS information using a Semantic Data Transformation Model (SDTM) to generate compact, task-agnostic semantic representations.

In various aspects, robust channel encoding can comprise: applying advanced channel encoding techniques to ensure resilient transmission over dynamic communication networks.

In various aspects, seamless transmission can comprise: delivering the encoded data stream to a destination Edge Server (ES) with ultra-low latency and high reliability.

In various aspects, precision decoding can comprise: reconstructing original semantic information through joint channel and semantic decoding, ensuring accurate, context-aware data recovery.

In some aspects, the method for efficient multi-task semantic communication leveraging a single Semantic Information Source (SIS), can further comprise semantic decoding of the SDTM is performed using data from a local knowledge base (KB) associated with the destination ES.

In some aspects, a method for locally coordinated federated learning (FL) across multiple distributed servers (DSs), can comprise: initiating a task set request by transmitting, from a source edge server (ES) to a destination edge server (ES), a request for a federated learning task set; synchronizing local knowledge bases (KBs) between the source ES and destination ES to ensure semantic consistency prior to task execution; propagating the task set request from the source ES to a first DS associated with the source ES; forwarding the task set request from the first DS to a second DS associated with the destination ES to establish cross-server coordination; transmitting task-specific learning configurations from the second DS to the destination ES; Providing SDTM status feedback by transmitting, from the destination ES to the second DS, a confirmation or adaptation signal for the received SDTM version; synchronizing distributed KBs between the first DS and second DS to enable seamless task set transmission and model alignment; and updating SDTMs dynamically by propagating an SDTM update from the first DS to the source ES and from the second DS to the destination ES, ensuring adaptive federated learning across the network.

In various aspects transmitting task-specific learning configurations from the second DS to the destination ES can comprise: a Semantic Data Transformation Model (SDTM) version for data interoperability, and a Task-Specific Machine Learning Configuration (TSMLC) defining model parameters for the federated task set.

In various aspects, the method for locally coordinated federated learning (FL) across multiple distributed servers (DSs), can further comprise: initiating a task set transfer by transmitting, from the source edge server (ES) to the destination ES, a request-to-transmit (RTS) signal soliciting approval for the task set delegation; responding to the RTS signal by transmitting, from the destination ES to the source ES, a clear-to-transmit (CTS) signal confirming availability and readiness to accept the task set; executing a multi-task semantic coordination (MCTS) protocol by transmitting, from the source ES to the destination ES, an optimized task set bundle containing semantic information for efficient processing; and finalizing the coordination by transmitting, from the destination ES to the source ES, an acknowledgement (ACK) signal verifying successful reception and readiness for task execution.

Some further example aspects of the devices described herein are provided in the following clauses.
Clause 1. A system of Multi-Task Semantic Communications (MTSC) via Federated Learning (FL), comprising: a central server (CS) configured to coordinate the federated learning (FL); one or more decentralized server (DS) nodes communicatively coupled to the CS and configured to coordinate localized training and transmission procedures of task adaptive neural network (NN) based Semantic Codec (SeCo) architectures; one or more edge server (ES) units coupled to the one or more DS nodes and configured to execute local computations for radio access networks (RANs); and one or more knowledge base (KB) database configured to store one or more of versioned NN model weights and task-specific SeCo configuration files.
Clause 2. The system of clause 1, wherein the SeCo architectures comprise Semantic Data Transformation Modules (SDTMs) for one or more semantic information related encoding or decoding procedures.
Clause 3. The system of clause 2, wherein the one or more DS nodes is further configured to manage one or more of local semantic transmissions and area-specific transmissions in diverse agent environments and application domains and training of SDTMs for updating NN weights or correct configurations.
Clause 4. The system of clause 1, wherein the RANs comprise one or more Wi-Fi and Internet of Things (IoT) access points (APs).
Clause 5. The system of clause 1, wherein the RANs are communicatively coupled with one or more 5G or 6G base stations (BSs).
Clause 6. The system of clause 1, wherein one or more ES comprises one or more cognitive sensing and communication modules configured to capture and process semantic information (SI).
Clause 7. The system of clause 1, wherein one or more of the DS nodes is configured to participate in semantic communication and further comprises: one or more Semantic Data Transformation Modules (SDTMs) configured to perform one or more of Task Specific Input Modifications (TSIMs), Task Specific Layer Modifications (TSLMs), and SI-related post-processing functions.
Clause 8. The system of clause 7, wherein the TSIMs modify input data by applying a subset of techniques including one or more of token insertion, task specific embedding, task specific positional encoding, or task specific byte patch insertion.
Clause 9. The system of clause 1, wherein the CS is configured to perform network-wide coordination of KB and global machine learning (ML) models.
Clause 10. A method of federated learning (FL) for Multi-Task Semantic Communication (MTSC), comprising: transmitting, from a centralized server (CS), a global knowledge base (KB) including Semantic Data Transformation Models (SDTM) models and configurations with one or more communicatively coupled local FL distributed servers (DSs); updating, at the one or more DSs, the SDTM models and the configurations; transmitting, from the one or more DSs, an updated SDTM model and the configurations to one or more communicatively coupled edge servers (ESs); extracting, at the one or more ESs, semantic information (SI); and checking, at the one or more DSs, a convergence using information from selected trained ESs.
Clause 11. The method of clause 10, wherein, if the checking fails, sharing updated SDTM models and the configurations from the one or more DSs.
Clause 12. The method of clause 10, wherein if the checking passes, the method further comprises: aggregating, by each of the one or more DSs, SDTM models and updating a local KB of the one or more DSs.
Clause 13. The method of clause 12, further comprising checking, at the CS, the convergence using the information from selected trained DSs.
Clause 14. The method of clause 13, wherein, if the checking fails, transmitting, from a the centralized server (CS), the global knowledge base (KB) including Semantic Data Transformation Models (SDTM) models and configurations with one or more communicatively coupled local FL distributed servers (DSs).
Clause 15. The method of clause 13, wherein, if the checking passes, the method further comprises: aggregating, by the CS, SDTM models and updating the global KB.
Clause 16. A method of multi-task semantic communication using a single Semantic Information Source (SIS), comprising: receiving, at a source edge server (ES), SIS information; performing cognitive sensing on the SIS information; performing semantic encoding of a Semantic Data Transformation Model (SDTM); performing channel encoding of semantically encoded information; transmitting the encoded channel to a destination ES; performing channel decoding of the semantically encoded information; and performing semantic decoding of the channel decoded information.
Clause 17. The method of clause 16, wherein performing semantic encoding of the semantically encoded information comprises using data from a local knowledge base (KB) of the source ES.
Clause 18. The method of clause 16, wherein performing semantic decoding of the channel decoded information comprises using data from a local knowledge base (KB) of the destination ES.
Clause 19. A method of locally coordinated federated learning (FL) using multiple distributed servers (DSs), comprising: transmitting, from a source edge server (ES) to a destination edge server (ES), a request for a task set; synchronizing, for the source ES and destination ES, a local knowledge base (KB); transmitting, from the source ES, a request for the task set to a first DS associated with the source ES; forwarding, from the first DS to a second DS associated with the destination ES, the request for the task set; transmitting, from the second DS to the destination ES, a Semantic Data Transformation Models (SDTM) version and a Task-Specific Machine Learning Configuration (TSMLC) for the task set; transmitting, from the destination ES to the second DS, a SDTM status for the task set; synchronizing, for the first DS and second DS, KB for a transmission of the task set; and transmitting a SDTM update from the first DS to the source ES and from the second DS to the destination ES.
Clause 20. The method of clause 19, further comprising: transmitting, from the source ES to the destination ES, a request or request-to-transmit (RTS) for the task set; transmitting, from the destination ES to the source ES, an acknowledgement or clear-to-transmit (CTS) for the task set; transmitting, from the source ES to the destination ES, a multi-task semantic coordination (MCTS) for the task set; and transmitting, from the destination ES to the source ES, an acknowledgement for the task set.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

It will be appreciated that various implementations of the above-disclosed and other features and functions, or alternatives or varieties thereof, can be desirably combined into many other different systems or applications. Also, that various presently unforeseen or unanticipated alternatives, modifications, variations, or improvements therein can be subsequently made by those skilled in the art which are also intended to be encompassed by the following claims.

What is claimed is:

1. A system of Multi-Task Semantic Communications (MTSC) via Federated Learning (FL), comprising:
a central server (CS) configured to coordinate the federated learning (FL);
one or more decentralized server (DS) nodes communicatively coupled to the CS and configured to coordinate localized training and transmission procedures of task adaptive neural network (NN) based Semantic Codec (SeCo) architectures;
one or more edge server (ES) units coupled to the one or more DS nodes and configured to execute local computations for radio access networks (RANs); and
one or more knowledge base (KB) database configured to store one or more of versioned NN model weights and task-specific SeCo configuration files.

2. The system of claim 1, wherein the SeCo architectures comprise Semantic Data Transformation Modules (SDTMs) for one or more semantic information related encoding or decoding procedures.

3. The system of claim 2, wherein the one or more DS nodes is further configured to manage one or more of local semantic transmissions and area-specific transmissions in diverse agent environments and application domains and training of SDTMs for updating NN weights or correct configurations.

4. The system of claim 1, wherein the RANs comprise one or more Wi-Fi and Internet of Things (IoT) access points (APs).

5. The system of claim 1, wherein the RANs are communicatively coupled with one or more 5G or 6G base stations (BSs).

6. The system of claim 1, wherein one or more ES comprises one or more cognitive sensing and communication modules configured to capture and process semantic information (SI).

7. The system of claim 1, wherein one or more of the DS nodes is configured to participate in semantic communication and further comprises:
one or more Semantic Data Transformation Modules (SDTMs) configured to perform one or more of Task Specific Input Modifications (TSIMs), Task Specific Layer Modifications (TSLMs), and SI-related post-processing functions.

8. The system of claim 7, wherein the TSIMs modify input data by applying a subset of techniques including one or more of token insertion, task specific embedding, task specific positional encoding, or task specific byte patch insertion.

9. The system of claim 1, wherein the CS is configured to perform network-wide coordination of KB and global machine learning (ML) models.

10. A method of federated learning (FL) for Multi-Task Semantic Communication (MTSC), comprising:
transmitting, from a centralized server (CS), a global knowledge base (KB) including Semantic Data Transformation Models (SDTM) models and configurations with one or more communicatively coupled local FL distributed servers (DSs);
updating, at the one or more DSs, the SDTM models and the configurations;
transmitting, from the one or more DSs, an updated SDTM model and the configurations to one or more communicatively coupled edge servers (ESs);
extracting, at the one or more ESs, semantic information (SI); and
checking, at the one or more DSs, a convergence using information from selected trained ESs.

11. The method of claim 10, wherein, if the checking fails, sharing updated SDTM models and the configurations from the one or more DSs.

12. The method of claim 10, wherein if the checking passes, the method further comprises:
aggregating, by each of the one or more DSs, SDTM models and updating a local KB of the one or more DSs.

13. The method of claim 12, further comprising checking, at the CS, the convergence using the information from selected trained DSs.

14. The method of claim 13, wherein, if the checking fails, transmitting, from a the centralized server (CS), the global knowledge base (KB) including Semantic Data Transformation Models (SDTM) models and configurations with one or more communicatively coupled local FL distributed servers (DSs).

15. The method of claim 13, wherein, if the checking passes, the method further comprises:
aggregating, by the CS, SDTM models and updating the global KB.

16. A method of multi-task semantic communication using a single Semantic Information Source (SIS), comprising:
receiving, at a source edge server (ES), SIS information;
performing cognitive sensing on the SIS information;
performing semantic encoding of a Semantic Data Transformation Model (SDTM);
performing channel encoding of semantically encoded information;
transmitting the encoded channel to a destination ES;
performing channel decoding of the semantically encoded information; and
performing semantic decoding of the channel decoded information.

17. The method of claim 16, wherein performing semantic encoding of the semantically encoded information comprises using data from a local knowledge base (KB) of the source ES.

18. The method of claim 16, wherein performing semantic decoding of the channel decoded information comprises using data from a local knowledge base (KB) of the destination ES.

19. A method of locally coordinated federated learning (FL) using multiple distributed servers (DSs), comprising:
transmitting, from a source edge server (ES) to a destination edge server (ES), a request for a task set;
synchronizing, for the source ES and destination ES, a local knowledge base (KB);
transmitting, from the source ES, a request for the task set to a first DS associated with the source ES;
forwarding, from the first DS to a second DS associated with the destination ES, the request for the task set;
transmitting, from the second DS to the destination ES, a Semantic Data Transformation Models (SDTM) version and a Task-Specific Machine Learning Configuration (TSMLC) for the task set;
transmitting, from the destination ES to the second DS, a SDTM status for the task set;
synchronizing, for the first DS and second DS, KB for a transmission of the task set; and
transmitting a SDTM update from the first DS to the source ES and from the second DS to the destination ES.

20. The method of claim 19, further comprising:
transmitting, from the source ES to the destination ES, a request or request-to-transmit (RTS) for the task set;
transmitting, from the destination ES to the source ES, an acknowledgement or clear-to-transmit (CTS) for the task set;
transmitting, from the source ES to the destination ES, a multi-task semantic coordination (MCTS) for the task set; and
transmitting, from the destination ES to the source ES, an acknowledgement for the task set.
